(19) United States
(12) Patent Application Publication
(10) Pub. No.: US 2005/0095326 A1
(43) Pub. Date: May 5, 2005

(54) Multi-headed confectionary

(76) Inventor: Ellias M. Najjar, Denver, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 10/697,732

(22) Filed: Oct. 29, 2003

(51) Int. Cl. A23G 1/00

(52) U.S. Cl. 426/134

(57) ABSTRACT

A lollipop with a plurality of stems extending radially from a central node with at least one candy affixed to the distal ends of the stem members. A candy may also be affixed to the central node. Additionally, multiple candies may be affixed to the ends of the stem members and the central node. The candies may vary in size, shape, color and flavor to provide the consumer with a plethora of confectionary options to indulge in with a single lollipop. A handling member is also affixed to the distal end of at least one non-candied stem member. The handling member, or members, affords the consumer with enhanced maneuverability so that the different candies may be rotated or spun for quick and comfortable engagement with the mouth.

### FIELD OF THE INVENTION

The present invention relates to novelty confectionary products. In particular, it relates to lollipops including one or more candies attached to multiple stems extending from a central node. Furthermore, the lollipops may include at least one handle-like member affixed to one or more stem members extending from the central node to enhance user maneuverability.

### BACKGROUND OF THE INVENTION

Lollipops have been well-known confectionary treats for several decades. The typical form of a lollipop is a thin usually cylindrical cardboard or plastic stick that has a piece of hard candy affixed to one end. The shapes of the candies in known conventional lollipops have substantially spherical, disk-like, or various other shapes. The candy is consumed by an individual holding the stick to position the candy in the mouth for licking and/or sucking. The stick is disposed of once the candy has been consumed.

Prior variations have been invented which make the consumption of lollipops more palatable or provide the consumer with ancillary entertainment features. However, these variations usually supply the consumer with only one candy affixed to one end of a stem. Thus, the consumer is limited to enjoying only one flavor or type of candy per lollipop. Furthermore, prior inventions provide the consumer with only basic delivery methods for engaging the candy with the mouth. In particular, lollipops traditionally have only one stem which doubles as a handle for gripping and maneuvering the candy into the mouth. The stem is typically gripped at its base opposite the candied end, thus the handling of a lollipop would be difficult and awkward if candies were affixed to both ends of the stem.

### SUMMARY OF THE INVENTION

The present invention solves the forgoing problems by providing a lollipop with a plurality of stems extending radially from a central node with at least one candy affixed to the distal ends of the stem members. A candy may also be affixed to the central node for consumption. Additionally, multiple candies may be affixed to the ends of the stem members and the central node. The candies may vary in size, shape, color and flavor to provide the consumer with a plethora of confectionary options to indulge in with a single lollipop. A handling member may also be affixed to the distal end of at least one non-candied stem member. The handling member, or members, affords the consumer enhanced maneuverability so that the different candies may be rotated or spun for quick and convenient engagement with the mouth.

### BRIEF DESCRIPTION OF THE DRAWINGS

FIG. 1 is a perspective view of a preferred embodiment showing the central node, four stem members extending radially from the central node, a candy affixed to the distal end of two stem members, and a handle member affixed to the distal end of two stem members.

FIG. 2 is a front view of the embodiment shown in FIG. 1.

FIG. 3 is a section taken along line 3-3 of FIG. 2.

FIG. 4 is an alternative embodiment showing a central node, three stem members extending radially from the central node, and a candy affixed to the distal end of each stem member.

FIG. 5 is an alternative embodiment showing a central node with two candied stem members and one third stem member forming a ‘Y’ configuration and extending from the central node.

### DETAILED DESCRIPTION

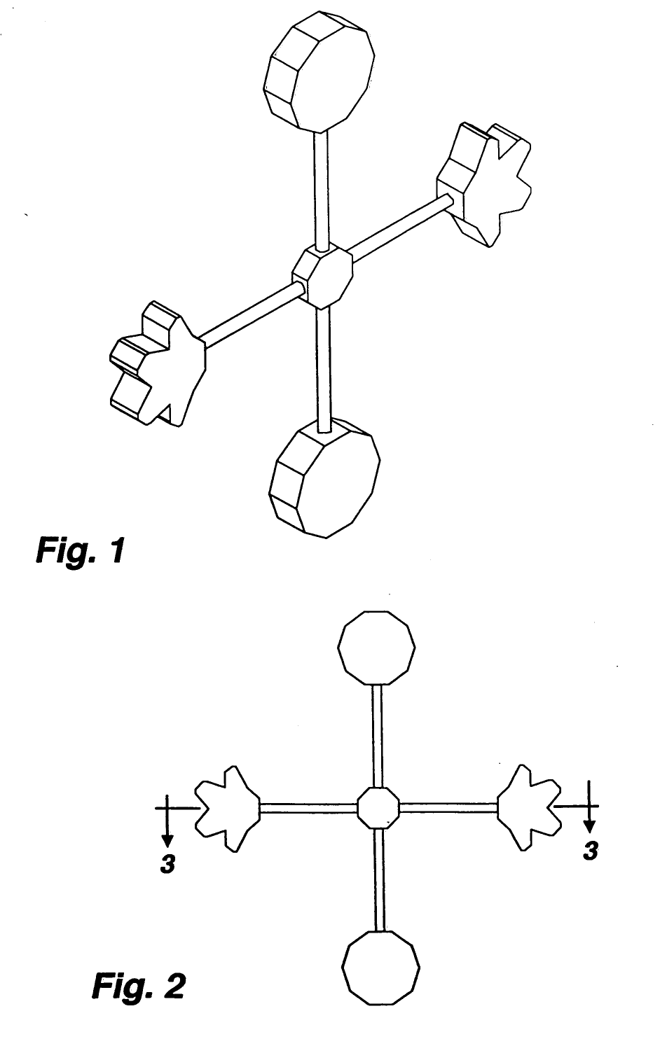

Referring to FIG. 1, a perspective view of the multiple candied lollipop 100 (herein “the lollipop”) is shown, including a central node 110 and four stem members 120 extending radially from the central node. A candy 130 is affixed to the distal end of two stem members 120 so that the candies are diametrically opposed across the central node 110. Furthermore, a handle member 140 is affixed to the distal end of two stem members so that the handle members are also diametrically opposed across the central node.

In a preferred embodiment there are four stem members 120 of substantially similar length extending radially from the central node 110. The stem members are configured in such a way that they are planar in relation and situated approximately ninety degrees apart so that the candies 130 and handle members 140 diametrically oppose one another, respectively. However, the lollipop 100 can include more or less stem members 120 of varying lengths, as seen in subsequent figures, and do not necessarily have to be planar in relation or situated in ninety degree gradations. Additionally, the stem members and central node can comprise of a plurality of candies 130 varying in size, shape, color and flavor.

FIG. 2, similar to FIG. 1, shows the lollipop 100 with the central node 110. Four stem members 120 extend radially from the central node. A candy 130 is affixed to the distal end of two stem members 120 and a handle member 140 is affixed to the distal end of the two remaining stem members. The stem members are planar in relation and are configured at ninety degree gradations. Thus, the candies 130 and handle members 140 diametrically oppose one another across the central node 110.

An axis is defined extending across the central node 110 from one handle member 140 to the other handle member. A user of the lollipop 100 can grip one or both handle members and twist or spin the lollipop so that the candies 130 and respective stem members 120 rotate about axis. This rotation or spinning enables a user to switch between different candies 130 located on separate stem members. In alternative embodiments, not shown, additional candied stem members 120 can extend radially from the central node 110 and be configured in a planar relation to the existing candied stem members, but perpendicular to axis 3. This configuration would provide a user with three or more candied stem members 120 accessible to the mouth by a mere twist of the handle members 140 about the axis.

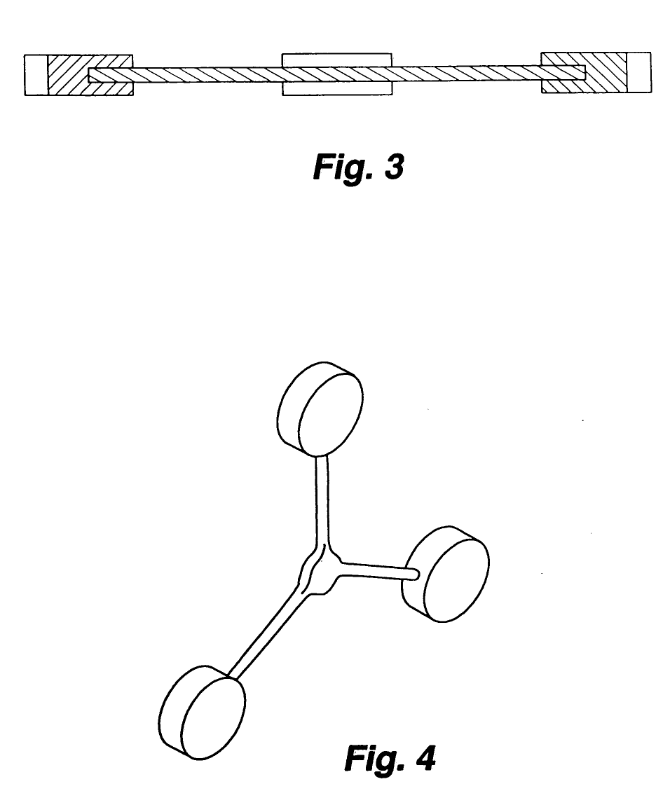

FIG. 3 shows a section view of the lollipop 100 with the central node 110. In this embodiment, the two radially extending stem members 120 are a single stem member 300 that is intersected by the central node. As in this embodiment, a stem member 300 providing two distal ends can be employed instead of two stem members 120 each terminating and connected together at the central node by a connector 112. The distal ends of the stem member 300 are attached to the handle members 140 by a press fit, edible adhesive, or any other suitable means. Additionally, although not shown, the stem members 120, 300 do not necessarily have to be straight in shape and form. The stem members may have curvatures or may be flexible so that only the candies 130 or handle members 140 are radially offset from the central node 110. This flexibility in form and shape can augment aesthetic as well as ergonomic characteristics of the lollipop 100.

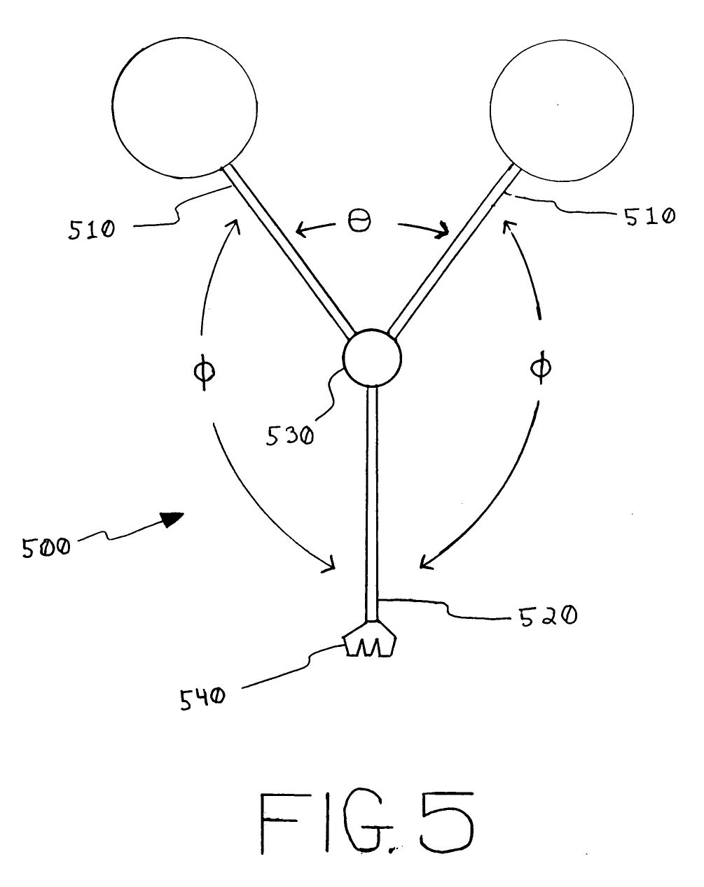

FIG. 4 shows an alternative embodiment of a lollipop 400 with only three stem members 410 extending radially from a central node 420. Accordingly, each stem member has a candy 430 attached to its distal end. As previously mentioned, the lollipop 400 is not limited to just two candied stem members 410 and may have as many appendages as desired. Although there are no stem members with an affixed handle member 140, a user may still grip the lollipop 400 around the central node 420 for comfortable handling.

FIG. 5 represents another embodiment of a lollipop 500 where two candied stem members 510 and a third stem member 520 form a ‘Y’ configuration protruding from a central node 530. In this embodiment, the two candied stem members extend radially from the central node preferably within 90 degrees of one another, but may exceed 90 degrees if desired. The third stem member 520 extends from the central node 530 in a direction generally opposite the two candied stem members and may have a handle member 540 affixed to its distal end. The angle of separation φ between a candied stem member 510 and the third stem member 520 is preferably calculated by:
φ=180°−θ/2
where θ represents the angle of separation between the two candied stem members 510. This calculation is preferred so that the third stem member 520 has an equivalent radial spacing between the two candied stem members 510 with respect to the central node 530. However, the third stem member may be skewed toward either candied stem member if desired.

Those skilled in the art will recognize that lollipop stems are typically made from cardboard or plastic materials and are thin and spherical in shape. The candies affixed to the stems can be any variety of hard candy confectionary with varying size, shape, color and flavor which are conducive for licking and/or sucking. The handle members 140 may have any shape, although hand-shapes are shown. The handle members may be either consumable confectionary, or a non-consumable such as wood, plastic, ceramic or stone. Also, the central node may be defined by a central portion of a single item extending from one candy to another, or on a single stem extending from one handle member to another handle member. The cross members extending between the candies and the handle members, respectively, may be continuous and overlap at the central node.

While the invention has been described with respect to a preferred embodiment thereof, it will be understood by those skilled in the art that various changes in detail may be made therein without departing from the spirit, scope, and teaching of the invention. Accordingly, the invention herein disclosed is to be limited only as specified in the following claims.

1. A lollipop with a central node comprising:
a plurality of first members extending radially from the central node; and
at least one candy affixed to the distal end of at least one of said first members.

2. A lollipop as in claim 1, further comprising:
at least one candy affixed to the distal ends of a plurality of said first members so that at least two candies share a diametrically opposed configuration across the central node.

3. A lollipop as in claim 1, further comprising:
at least one second member secured to the distal end of at least one of said first members.

4. A lollipop as in claims 1, further comprising:
at least one candy affixed to the central node.

5. A lollipop as in claim 2, further comprising:
at least one candy affixed to the central node.

6. A lollipop as in claim 2, further comprising:
at least one candy affixed to the distal end of at least one of said first members so that the candy is radially offset with respect to the central node.

7. A lollipop as in claim 5, further comprising:
at least one candy affixed to the distal end of at least one of said first members so that the candy is radially offset with respect to the central node.

8. A lollipop as in claim 3, further comprising:
at least one candy affixed to the distal end of at least one of said first members so that the candy is radially offset with respect to the central node.

9. A lollipop as in claim 3, further comprising:
at least one candy affixed to the central node.

10. A lollipop as in claim 9, further comprising:
at least one candy affixed to the distal end of at least one of said first members so that the candy is radially offset with respect to the central node.

11. A lollipop as in claim 2, further comprising:
at least one second member secured to the distal end of at least one of said first members.

12. A lollipop as in claim 11, further comprising:
at least one candy affixed to the distal end of at least one of said first members so that the candy is radially offset with respect to the central node.

13. A lollipop as in claim 11, further comprising:
at least one candy affixed to the central node.

14. A lollipop as in claim 13, further comprising:
at least one candy affixed to the distal end of at least one of said first members so that the candy is radially offset with respect to the central node.

15. A lollipop as in claim 4, further comprising:
at least one candy affixed to the distal end of at least one of said first members so that the candy is radially offset with respect to the central node.
